(19) United States
(12) Patent Application Publication
(10) Pub. No.: US 2008/0089074 A1
(43) Pub. Date: Apr. 17, 2008

(54) High Bay Lighting Shade

(76) Inventor: Brian E. Kuehne, Melbourne Beach, FL (US)

Correspondence Address: BARNES & THORNBURG LLP, P.O. BOX 2786, CHICAGO, IL, 60690-2786, US

(21) Appl. No.: 11/871,317

(22) Filed: Oct. 12, 2007

Related U.S. Application Data
(60) Provisional application No. 60/829,189, filed on Oct. 12, 2006.

(51) Int. Cl. F21V 1/26

(52) U.S. Cl. 362/360; 362/351

(57) ABSTRACT

A high bay light fixture shade including a frame configured for suspension about a high bay lighting fixture having one or more side panels that may be attached to the frame to direct light output from the high bay lighting fixture.

The present disclosure claims priority to U.S. Provisional Patent Application Ser. No. 60/829,189, filed Oct. 12, 2006.

### BACKGROUND

The present disclosure relates generally to a shade for high bay lighting fixtures. In particular, the present disclosure is for a removable flexible shade to control the direction of light emitted from a high bay lighting fixture.

High bay lighting fixtures are designed for applications where the ceiling height is usually greater than twenty feet. Usually, the lighting fixtures for an entire room, or large portions of the room, are on a single electrical circuit, making it difficult or impossible to turn off a single light fixture without physically disconnecting the wires. Such applications for high bay lighting fixtures include convention halls, gymnasiums, factories, warehouses, garages, and other environments having a high ceiling.

In a convention hall application, high bay lighting fixtures are permanently mounted, usually in a regular rectangular grid pattern. Typically, the convention hall will host trade shows having exhibitors that rent spaces on the convention floor for booths displaying and promoting their goods and/or services. The booths may be arranged in a pattern that may not correspond to the layout of the lighting fixtures above. The exhibitors may have various electronic audio/visual displays. Stray light from overhead lighting may interfere with these booth displays. An exhibitor may wish to turn off or block the light from a particular fixture to enhance the visual display of the exhibitor's booth. However, as previously discussed, it is usually difficult, if not impossible to turn off a single light fixture in a large convention hall. Also, since a certain amount of lighting is required for safety, certain lights may need to remain on, in spite interfering with of an exhibitor's display.

It is therefore desirable to have a shade that is quickly attachable to, and removable from, a high bay lighting fixture to control the direction of light emitted from the lighting fixture.

### SUMMARY

The present disclosure relates to a shade for a high bay lighting fixture. The shade of the present disclosure has a first frame configured for suspension about a high bay lighting fixture, and one or more opaque fabric side panels that may be attached to the first frame to direct light output from the high bay lighting fixture.

In one aspect of the present disclosure, the first frame includes a number of panel mounts configured to engage fasteners on an opaque fabric side panel. The panel mounts comprise a plurality of chassis-mount snaps configured to engage snaps on the fabric side panel. One or more fabric side panels may be disposed about the entire perimeter of the first frame. Side panels may overlap when disposed about the full perimeter of the first frame. Alternatively, a side panel may be disposed about a portion of the perimeter of the first frame.

In another aspect of the present disclosure, fabric side panels may include a first set of fasteners positioned at one end and a second set of fasteners positioned at an opposite end. The fasteners configured to allow for a first side panel to be attached to the first frame and a second side panel to be attached to the first side panel. This aspect of the disclosure allows multiple side panels to be coupled together to extend the length of the shade.

In another aspect of the present disclosure, a second frame may be suspended from the first frame. The second frame may have an opaque bottom panel attached to block light in the downward direction. Side panels may include fasteners for attachment to both the first frame and the second frame. An alternative embodiment may have a transparent colored theatrical gel in place of the opaque bottom panel to direct colored light downward.

### BRIEF DESCRIPTION OF THE DRAWINGS

The present disclosure will be described hereafter with reference to the attached drawings which are given as non-limiting examples only, in which:

FIG. 1 is a side elevation view of a shade of the present disclosure mounted about a high bay lighting fixture;

FIG. 2 is a plan view of a frame assembly of the shade of FIG. 1;

FIG. 3 is a detailed view showing a mounting plate having an eyebolt and two set screw cones engaging receiving holes in a lower frame segment;

FIG. 4 shows a quick clasp engaging an eyebolt of a lower frame segment;

FIG. 5 is a detailed view showing a side panel drape of the shade of FIG. 1;

FIG. 6 is a detailed view of a bottom panel drape for the shade of FIG. 1; and

FIG. 7 shows a shade of the present disclosure having a two fabric side panels connected together.

### DETAILED DESCRIPTION

While the present disclosure may be susceptible to embodiment in different forms, there is shown in the drawings, and herein will be described in detail, embodiments, with the understanding that the present description is to be considered an exemplification of the principles of the disclosure and is not intended to be exhaustive or to limit the disclosure to the details of construction and the arrangements of components set forth in the following description or illustrated in the drawings.

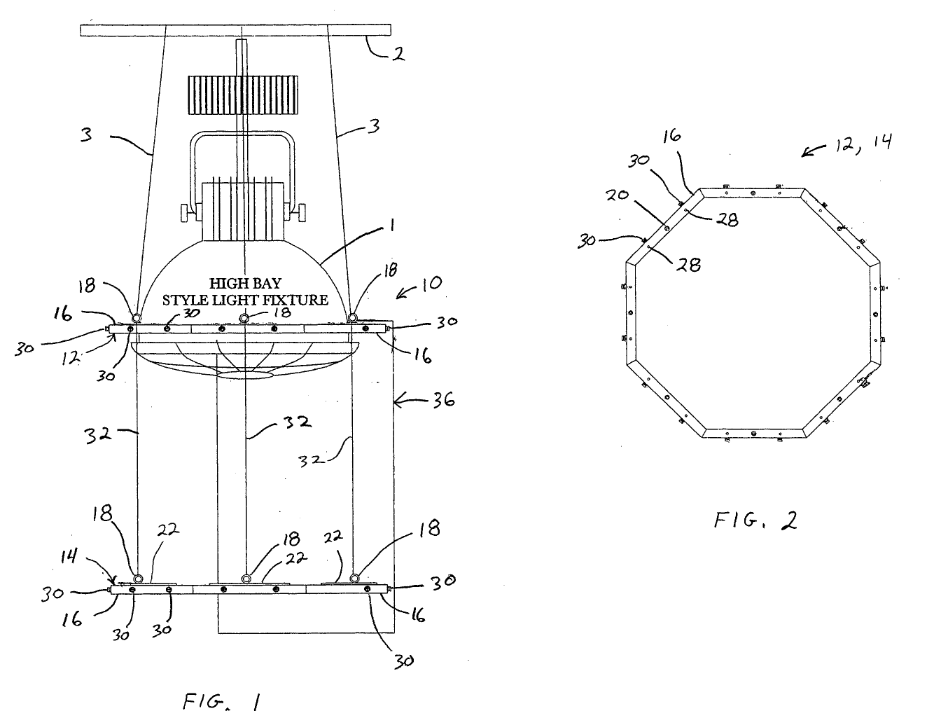

FIG. 1 shows a shade 10 of the present disclosure mounted about a high bay light fixture 1. The high bay light fixture 1 is mounted to a building structural component 2 such as a truss, bar joist, beam, ceiling, or other structural member. The shade 10 is suspended about the high bay light fixture 1 from a structural component 2 according to local practice and code by a suspension member 3 without actually being attached to the light fixture.

The shade 10 includes a first frame 12 and may also include a second frame 14. First frame 12 and second frame 14 are configured in a planar arrangement and may include one or more frame segments 16. In the exemplary embodiment, each frame includes eight frame segments 16 arranged in an octagon as shown in FIG. 2. Each frame segment 16 is fabricated from square stock aluminum tubing and welded to adjacent segments. Although the embodiment shown in FIGS. 1 and 2 includes octagonal frames, it should be apparent that any configuration enabling disposition of the frame about a light fixture would be acceptable and within the scope of the present disclosure, including a circular frame, hexagonal, decagonal (10 frame segments), dodecagonal (12 frame segments), etc. Also, it is not necessary that the first and second frames 12, 14 be of the same geometric configuration. Furthermore, as explained below, second frame 14 may be omitted entirely.

On the first frame 12, each frame segment 16 has a first frame mount that includes an eyebolt 18 threadedly connected to a blind rivet 20 mounted in the frame segment 16. Eyebolts 18 are configured to connect to suspension members 3 for attachment to a building structure. Side panel mounts 30 are attached to the outside of each frame segment 16. The exemplary embodiment includes male chassis-mount snaps for the side panel mounts.

A fabric side panel 36 is attached to the first frame 12. As shown in FIG. 5, the fabric side panel 36 is a generally opaque rectangular piece of heat and flame resistant fabric such as that sold under the brand name FIREMAN'S SERGE™ by Dazian Fabrics. The fabric side panel 36 includes a number of fasteners 38 along the top edge. Fasteners 38, as shown in the exemplary embodiment, are male/female snaps configured with the female end oriented inward and the male end oriented outward. The female side of male/female fasteners 38 are configured to cooperate with the chassis-mount snaps 30 on the first frame 12. Fabric panel 36 also has a number of male/female fasteners 42, positioned along the bottom edge configured with the female end oriented inward and the male end oriented outward as with the upper fasteners 38. The male/female snaps allow multiple fabric side panels 36 to be attached together, and also allows fabric side panels to be folded back and secured to provide for adjustment of the amount of light blocked.

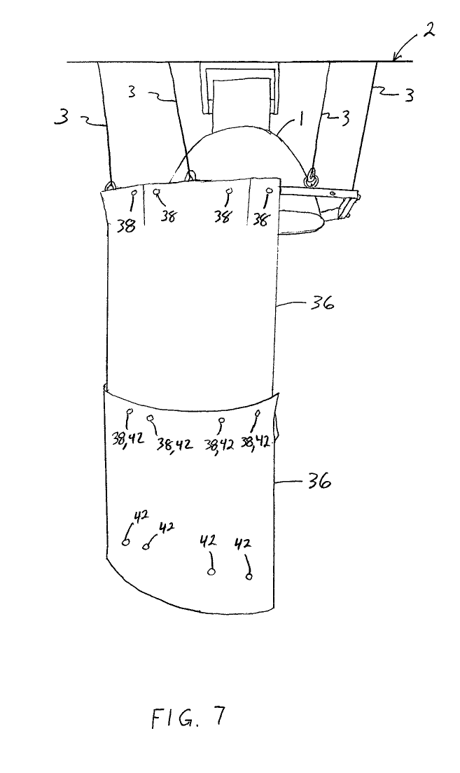

In the embodiment shown, fabric side panel 36 is configured to attach to half of the perimeter of first frame 12 by fasteners 38 in cooperation with side panel mounts 30. A second fabric side panel (not shown) is configured to attach to the other half of the perimeter of first frame 12 overlapping fabric side panel 36 by one snap. Also, the snaps 42 along the bottom edge allow not only for overlapping configuration, but additional side panels may be snapped together to extend the overall length of the panel, as shown in FIG. 7.

By having the fabric side panel 36 configured to attach to half of the first frame 12, the fabric side panel may be positioned to block the light from the high bay lighting fixture 1 for about half of the frame perimeter. An additional side panel 36 may be attached about the other half of the perimeter of frame 12 to entirely block any sideward dispersion of light, directing the light directly downward. Although the exemplary embodiment is shown with a fabric side panel 36 encircling half of the high bay lighting fixture 1, other fractional or whole portions covered by the fabric side panel are fully within the scope of the present disclosure. Also, male/female fasteners 38 and 42 allow the fabric side panel 36 to be folded back and snapped to itself, allowing for greater adjustability.

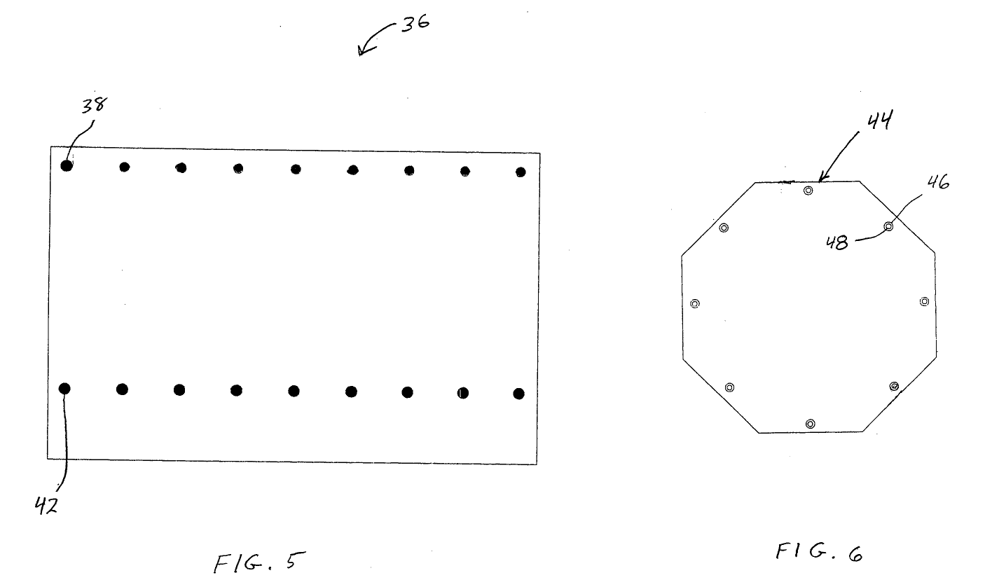

Referring again to FIG. 1, a second frame 14 may be attached to the first frame 12 by frame hangers 32. In the present embodiment, frame hangers 32 may be 1/16″ to ⅛″ aircraft cable or wire rope. Each length of cable has a closed loop at one end that is secured to an eyebolt 18 on the first frame 12. The lower end of each length of cable 32 is secured to a corresponding eyebolt 18 on the second frame 14 by a quick clasp 34 as shown in FIG. 4.

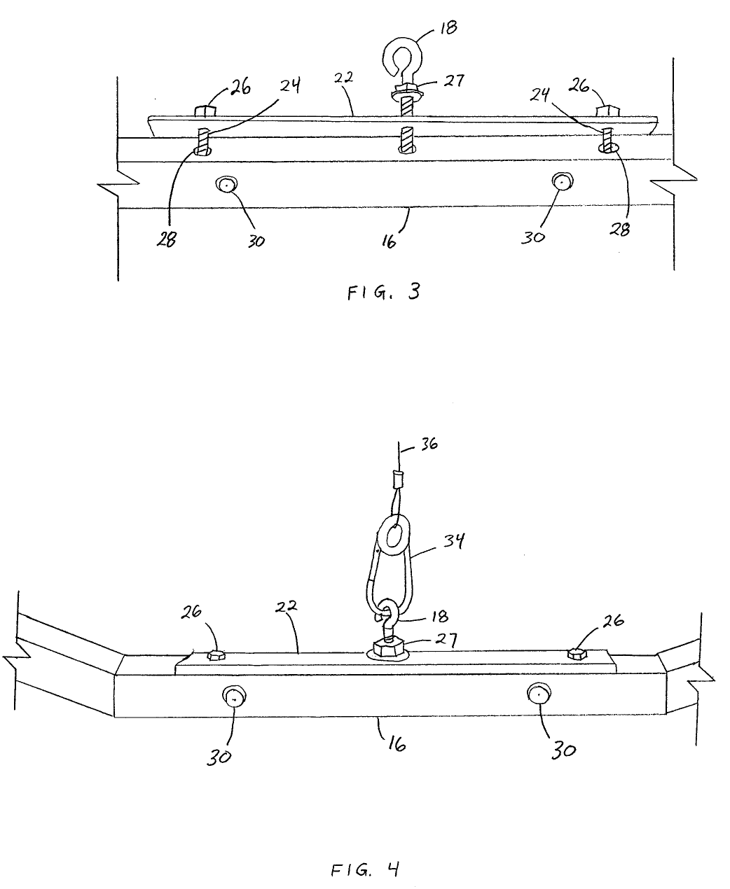

On the second frame 14, a mounting plate 22, is attached to an upper surface of each frame segment 16. The mounting plate 22 includes set screw cones 24 extending through the mounting plate 22 and secured by jamb nuts 26, as shown in FIGS. 3 and 4. Receiving holes 28 are provided on the upper surface of the frame segment 16 configured to receive the set screw cones described. An eyebolt 18 passes through the mounting plate 22 and threadedly engages blind rivet 20. A serrated flange nut 27 threadedly engages eyebolt 18 and is positioned adjacent to the mounting plate 22, securing it to the frame segment 16. Male chassis-mount snaps 30 are attached to the outside of each frame segment 16.

If it is desirable to entirely block out light, an opaque bottom panel 44, as shown in FIG. 6 may be attached to the top of the second frame 14. Bottom panel 44 is made of the same material as side panels 36. Bottom panel 44 has grommets 46, each grommet defining an aperture 48 configured to correspond to the eyebolts 18 in the second frame 14. The bottom panel 44 is placed on top of second frame 14 aligning apertures 48 with the blind rivets 20. Eyebolts 18 are then threaded into the blind rivets 20 and bottom panel 44 is secured by the serrated flange nut 27 threadedly engaged to eyebolt 18.

It may be desirable to have colored light directed in a particular direction instead of blocking light entirely. Colored theatrical gel may be substituted for bottom panel 44. Theatrical gel is transparent and may be of any desired color. By replacing opaque bottom panel 44 with a colored gel, colored light can be directed downward. A mounting plate 22 is placed on top of bottom panel 44 and secured to the second frame 14 by an eye bolt 18 screwed into blind rivet 20. The set screw cones 24 press down on bottom panel 44 and engage receiving holes 28. In doing so, the set screw cones 24 puncture the theatrical gel while mounting plate 22 presses the gel against second frame 14, thus securing the gel.

Referring again to FIG. 7, second frame 14 may be omitted if only horizontal control of light is desired. Fabric side panels 36 may be hung from only the first frame 12 and allowed to hang free as shown. This saves effort and cost if an opaque bottom panel 44 or colored theatrical gel are unnecessary for a particular application.

1. A shade for a light fixture comprising:
a first frame configured for disposition about the light fixture; and
a first side panel removably attached to said first frame.

2. The shade of claim 1 wherein said first frame defines a perimeter, said first side panel being removably attached to less than the full perimeter of said first frame.

3. The shade of claim 1 wherein said first frame defines a perimeter, and wherein one or more side panels are attached about said perimeter.

4. The shade of claim 1 wherein said first side panel includes an upper edge and a lower edge, said first side panel being attached to said frame proximate to said upper edge, and a second side panel being attached to said first side panel at said lower edge.

5. The shade of claim 1 wherein the first frame includes at least one panel mount configured for removable attachment of said first side panel.

6. The shade of claim 5 wherein said first side panel includes at least one fastener configured to cooperate with said panel mount for removable attachment of said first side panel to said first frame.

7. The shade of claim 6 wherein said first frame further includes a plurality of panel mounts configured to cooperate with a plurality of fasteners positioned on said first side panel proximate to an upper edge.

8. The shade of claim 7 wherein said first side panel further includes a plurality of fasteners positioned proximate to a lower edge; and
said shade further comprises a second side panel including a plurality of fasteners positioned proximate to an upper edge, wherein the fasteners positioned proximate to the lower edge of said first side panel and the fasteners positioned proximate to the upper edge of said second side panel are configured to cooperate for removable attachment of said second side panel to said first side panel.

9. A shade for a light fixture comprising:
a first frame configured for disposition about the light fixture;
a second frame attached to and spaced apart from said first frame; and
a first side panel configured for removable attachment to said first frame and said second frame.

10. The shade of claim 9 further comprising a bottom panel attached to said second frame.

11. The shade of claim 10 wherein said bottom panel comprises an opaque fabric.

12. The shade of claim 10 wherein said bottom panel comprises a polymeric material.

13. The shade of claim 9 further comprising at least one frame hanger connecting said second frame to said first frame.

14. The shade of claim 10 further comprising a mounting plate coupled to said second frame for attachment of said bottom panel, wherein said bottom panel is positioned between said second frame and said mounting plate.

15. The shade of claim 9 further comprising a plurality of panel mounts positioned on said first frame configured to cooperate with a plurality of fasteners positioned on first side panel for removable attachment of said first side panel to said first frame.

16. The shade of claim 15 further comprising a plurality of panel mounts positioned on said second frame configured to cooperate with a plurality of fasteners positioned on first side panel for removable attachment of said first side panel to said second frame.

17. The shade of claim 9 wherein said first frame defines a perimeter, said first side panel being removably attached to less than the full perimeter of said first frame.

18. The shade of claim 9 wherein said first frame defines a perimeter, and wherein one or more side panels are removably attached about said perimeter.

19. A kit for a for a high bay light fixture shade, the shade configured for suspension from a building structural member, said kit comprising:
a first frame configured for disposition about the light fixture, said first frame including a plurality of panel mounts;
a plurality of suspension members configured for attachment of said first frame to the structural member;
a second frame including a plurality of panel mounts;
a plurality of frame hangers configured for connecting said second frame to said first frame; and
at least one side panel including a plurality of fasteners, said fasteners configured to cooperate with said panel mounts on said first frame for releasable attachment of said side panel to said first frame.

20. The kit of claim 19 further comprising a bottom panel configured for attachment to said second frame, wherein said bottom panel is selected from the group consisting of an opaque fabric and a polymeric film.
